(19) United States
(12) Patent Application Publication
(10) Pub. No.: US 2010/0131517 A1
(43) Pub. Date: May 27, 2010

(54) System and method for ranking and grouping results of code searches

(75) Inventors: Jeff Huang, Seattle, WA (US); Michael Cameron Jones, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc., Sunnyvale, CA (US)

(21) Appl. No.: 12/275,593

(22) Filed: Nov. 21, 2008

(51) Int. Cl. G06F 7/06; G06F 17/30; G06F 7/00

(52) U.S. Cl. 707/752; 707/E17.014

(57) ABSTRACT

A method of sorting search results associated with a function search performed on a source code repository comprises receiving the search results, wherein each search result is either a function definition or a function usage, grouping the search results into groups according to a grouping function, ranking the groups according to a ranking function, and displaying the grouped and ranked search results.

### BACKGROUND

1. Field of the Invention

Aspects of the present invention relate generally to grouping and ranking the results of a search made on a source code repository.

2. Description of Related Art

Searching through source code is an essential function for most software developers. Conventionally, the results of such searches are unsorted, ungrouped, uncategorized, and generally are difficult to navigate. Indeed, most source code search mechanisms simply return the filenames of the files containing the search query and a line number within the respective file where the search query appears.

Thus, it is desirable to increase the usefulness and display of the results of a search performed on a source code repository.

### SUMMARY

In light of the foregoing, it is a general object of the present invention to provide a system and method for grouping and ranking the results of a search performed on a source code repository.

### BRIEF DESCRIPTION OF THE DRAWING FIGURES

FIG. 1 is a functional block diagram of the general architecture of an exemplary embodiment of the present invention.

FIG. 2 is a simplified block diagram illustrating the path a search request may take in accordance with the detailed description.

FIG. 3 is an example of how grouped and ranked search results may be displayed.

FIG. 4 is a flowchart that illustrates generally a process of grouping and ranking function search results.

### DETAILED DESCRIPTION

Detailed descriptions of one or more embodiments of the invention follow, examples of which may be graphically illustrated in the drawings. Each example and embodiment is provided by way of explanation of the invention, and is not meant as a limitation of the invention. For example, features described as part of one embodiment may be utilized with another embodiment to yield still a further embodiment. It is intended that the present invention include these and other modifications and variations.

Aspects of the present invention are described below in the context of providing a system and method for grouping and ranking the results of a search performed on a source code repository.

Throughout this disclosure, reference is made to “source code repository,” which is used to denote a collection of source code. It will be appreciated that the repository may comprise source code from a single project, application, etc., or source code from varying and disparate projects, applications, etc.

Throughout this disclosure, reference is made to “package,” which is used to denote related source code. For example, package may refer to a particular package, project, framework, etc., and may be as granular as a particular file or file path.

Throughout this disclosure, reference is made to “system,” which is used to denote a source code repository coupled to a mechanism by which the repository may be searched. For example, consider an open source project that makes the source code of the project freely available. The source code of such a project may be browsable and/or searchable through an interface (e.g., a web page).

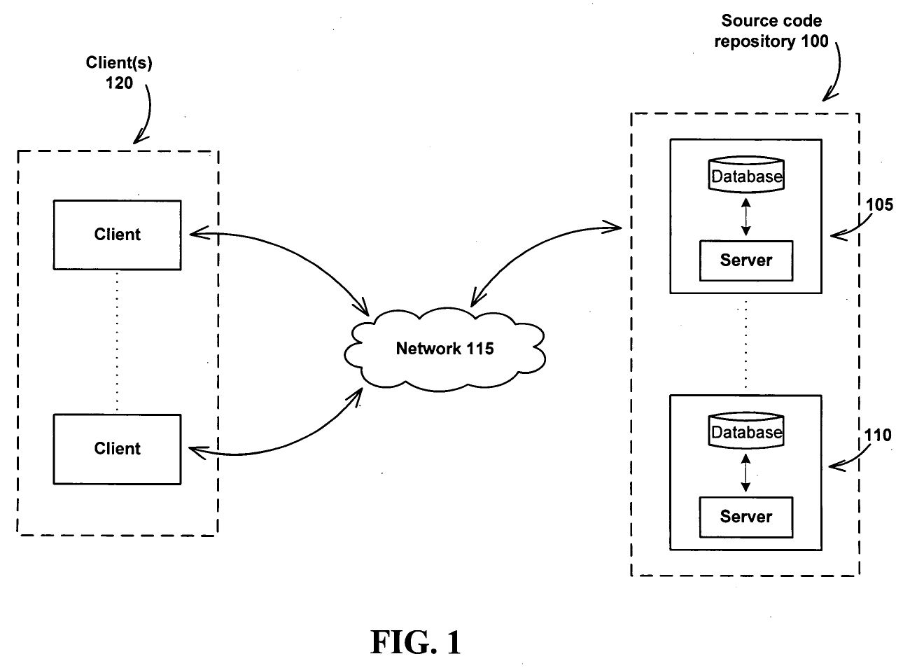

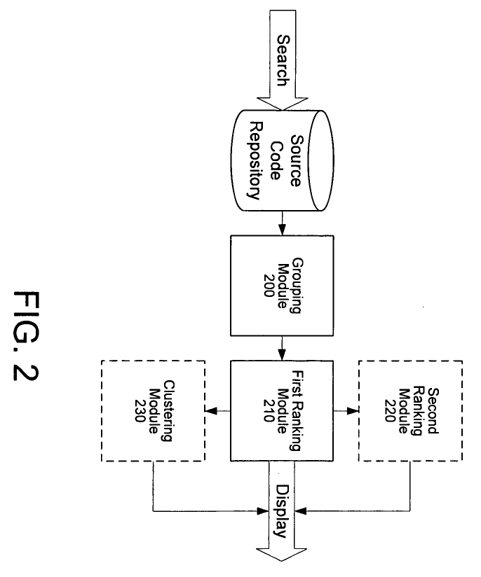

FIG. 1 is a simplified block diagram illustrating how the invention may be employed in accordance with the detailed description. Source code repository 100, as described above, may include any of a number of servers, databases, etc. required for its operation (e.g., servers 105 and 110); source code repository 100 also may implement the methods used to search through the source code repository and provide grouped and ranked search results (see FIG. 2), as described herein. Client 120 may be a user at a computer accessing (and searching through) source code repository 100. Source code repository 100 and client 120 are linked together through Network 115 (e.g., the Internet, etc.).

FIG. 2 is a simplified block diagram illustrating the path a search request may take in accordance with one aspect of the invention. It will be appreciated that modules 200, 210, 220, and 230 as described herein and in FIG. 2, may be implemented in hardware and/or a computer readable medium, and that each module may reside on a single device or separate devices, and in any combination. Grouping module 200 receives the results of a search performed on the source code repository and groups the search results according to various factors, as described herein. The groups of results are then received by First Ranking Module 210, where the groups are ranked according to various factors, as described herein. In an embodiment, the groups of search results, as ranked, may be received by Second Ranking Module 220, where the search results belonging to a particular group are ranked amongst themselves. In an embodiment, the groups of search results, as ranked may be received by Clustering Module 230, where the search results belonging to a particular group are clustered by similarity, ranked by resulting cluster, and then the search results of each cluster are ranked amongst themselves according to various factors, as described herein.

Depending on what is being searched for, the search itself may be trivial to implement. For example, when searching for constants, the system may use available tools (e.g., grep on a Unix-based system) to parse individual files looking for the search term. Similarly, when searching for a particular file name, the system can simply call on, for example, the UNIX search tool, find.

Though searching for constants and file names may be rather easy to implement, function searching can be more complicated. There are generally three forms of functions in source code, namely declarations, definitions and usages, though the number and names of these constructs may differ from language to language. As is known, declarations generally establish the name of the function and the number and type of its parameters; a declaration or function signature usually consists of a return type, a name, and a parameter list, including order and type. A function definition generally contains a function declaration and the body of the function (i.e., the code comprising the actual function). Typically, declarations are placed in header files (or similar), while function definitions appear in source files.

Function usages are where, in the code, the functions are called. For example, there may be a function, fooBar( ), defined in a first source file. Functions in second and third source files may cause fooBar( ) to be executed, and each such instance can be considered a usage of the fooBar( ) function. Usages also may include the surrounding code, which can be limited or expanded as desired. For example, fooBar( ) may be called from within another function, and the usage of fooBar( ) may comprise not only the exact line where it is called, but, say, five lines above and below that line. As another example, usage may be defined to comprise not only the function at issue, but also other function calls that are in close proximity to the function call of the function at issue (e.g., the three function calls closest, in a source file, to the function call associated with a search query, etc.).

Currently, most systems that provide the ability to search a source code repository return results that are unsorted, ungrouped, uncategorized and are generally difficult to navigate. Typically, these searching mechanisms simply return the filename(s) of the file(s) in which the function resides, and the line number(s) at which the function exists within the file(s). Such results are not always helpful in light of the fact that generally, when a search is done on a search code repository, the searcher is interested in a function's implementation and/or examples of its usage.

In light of the above, a search result in the context of the invention may be a function definition or a function usage associated with a function search query. As an example, consider again the fooBar( ) function, definitions of which may exist in the source code repository in the following variations:

int fooBar(bool avgScore) {<code for definition>}

string fooBar(bool avgScore) {<code for definition>}

string fooBar(bool avgScore) {<code for definition>}

Even though the second and third examples above may have the same function signature, their definitions may be different, in which case, each of these definitions may be considered a search result when a search of “foobar” is made in the source code repository. In addition to the definitions, the function usages associated with “foobar” also may be returned as search results, which usages may correspond to invocations of the functions defined by the definitions.

The results of a function search may be enhanced by grouping and ranking them according to various factors, including by definitions, signatures and usages. In this context, search results are defined by their grouping, which grouping may be based on various factors. For the remainder of the detailed description, search results are grouped according to function signature, such that each group of search results (i.e., function definitions and usages) will correspond to a unique function signature; however, it will be appreciated that grouping may be done according to other factors, such as, for example, by function definition (i.e., each function definition would define a group, and each definition's associated usages, according to, say, package information, would be a part of that group).

A second limitation of current searching technology is that search results associated with a source code search generally are not ranked, but rather are listed in some arbitrary order (e.g., by the number of function arguments, etc.), which usually is not much help to the searcher. By ranking the search results, as grouped, according to a less arbitrary metric, the usefulness of their presentation to the searcher may be increased dramatically.

In an embodiment, groups of search results may be ranked by treating function usages as “inbound links,” similarly to how some web-based search engines work (i.e., by assigning a “score” to a particular web page, which score is informed by at least the number and associated ranks of web pages that link to the particular web page). Under this approach, the number of times a function with a particular function signature is called by other functions from within the search code repository may determine that function signature's (group) rank as between other function signatures (groups) with the same (or similar) function name. A group's rank also may be determined by the number of definitions in the group; for example, the more definitions within a group, the higher the group's rank.

The ranking of groups also may be based on a weighting scheme, wherein more ‘diverse’ usages and/or definitions may be given higher or lower weights. For example, assume that a search is done for “getvalue,” and in the source code repository there are three function definitions named “getValue”—functions A, B, and C—where each has a different function signature (and thus each belongs to a different group). Assume also that 1.) A is called only from other functions in the same class in which it is defined; 2.) B is called from other functions the same amount of times as A, but from several different classes, each of which exists within the same package; and 3.) C is called slightly fewer times than A and B, but from many different packages. In such a situation, and based on diversity of usage, the group associated with function C may be ranked over the group associated with function B, which may be ranked over the group associated with function A, because C is called from a larger breadth of contexts than B, and because B has a more diverse calling context than A. It will be appreciated that these and other factors may be combined in various combinations (e.g., a group's rank may be based on its total number of usages and definitions, etc.)

Ranking and grouping also may take place within each group, as between that group's definitions and/or usages. For example, definitions may be ranked according to the number of function usages that correspond to a particular definition (determined by, for example, the package(s) to which each usage/definition belongs). As discussed above with respect to ranking groups, definitions also may be ranked within a group using a weighting scheme, wherein, for example, more ‘diverse’ usages are given higher weights, such that definitions associated with more diverse usages may be ranked higher than definitions associated with usages that are less diverse.

Within a group, usages also may be ranked, which ranking can be accomplished in various ways. For example, usages may be ranked alphabetically, according to, for example, the packages that contain the particular usage.

As another example of ranking usages within a group, consider clustering. Suppose a user searches for the function “foobar.” In the search results, there may be several definitions of the function “fooBar,” and several usages. The associated usages may be clustered according to similar patterns of code statements surrounding the “fooBar” function call. For example, assume that, for three of the found usages, function calls are made to “function1” and “function2” in the few lines before the “fooBar” function call. Assume also that two other usages call “function3” before “fooBar,” and “function4” after “fooBar.” In this example, the three usages corresponding to “function1” and “function2” may form a pattern of code statements, and may be clustered together in a single cluster, say cluster A, and the usages corresponding to “function3” and “function4” may form a different pattern of code statements and may be clustered together in a different cluster, say cluster B. These clusters may then be ranked against each other; for example, cluster A before cluster B because there are more instances of the pattern associated with cluster A (three) than the pattern associated with cluster B (two).

In an embodiment, the usages within each cluster may be ranked within the cluster according to various criteria. For example, they may be ranked based on their similarity to the canonical form of the respective cluster's pattern. Going back to the cluster A above, consider 1.) that the first usage calls “function1” immediately before “function2,” and “function2” immediately before “fooBar,” with no other function calls between them; 2.) that the second usage calls “function1,” then “randomFunction1,” then “function2,” and then “fooBar”; and 3.) that the third usage calls “function1,” then “randomFunction1,” then “randomFunction2,” then “function2,” and then “fooBar.” In such an instance, where the canonical form of the pattern is simply function1 before function2 before fooBar, the first usage may be ranked before the second usage, and the second usage may be ranked before the third usage.

Ranking of usages within a cluster also may be informed by the number of lines (or some similar metric) it takes to complete the pattern; for example, a usage that completes the pattern in five lines may be ranked higher than a usage that completes it in four.

Ranking of usages within a cluster (or similarly, within a group) also may be informed by a readability metric, such as for example, where heavy commenting or shorter expressions are favored over code with few comments or overly verbose expressions, respectively.

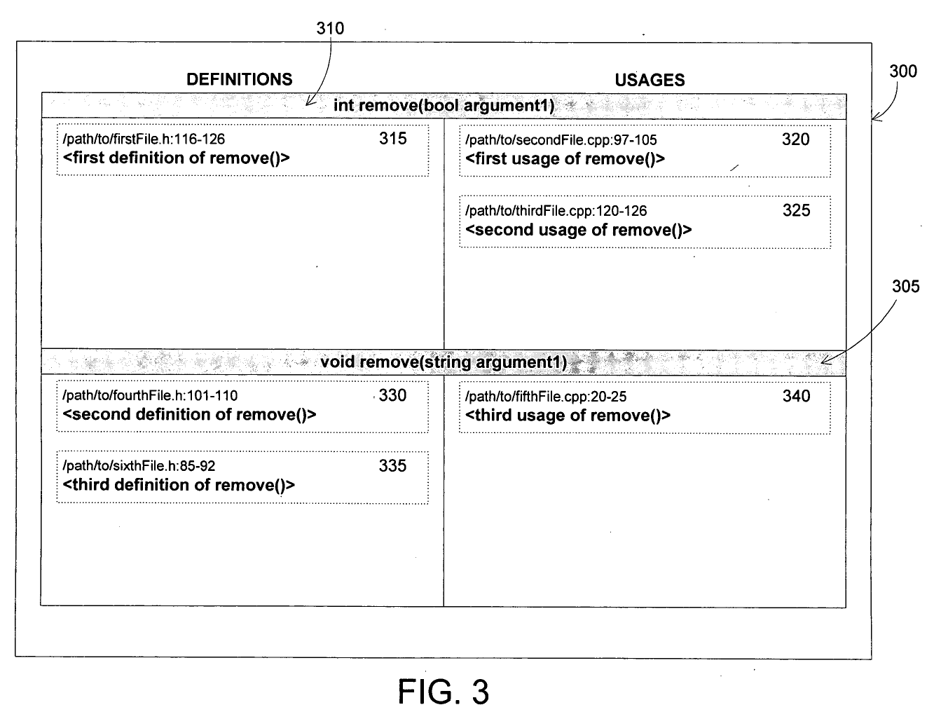

It will be appreciated that each of the grouping, ranking and clustering methods described herein may be combined in various combinations as desired or warranted. FIG. 3 is example of how grouped and ranked search results may be displayed to the searcher. In the example, a function search for the query term “remove” was performed on a source code repository, which function search returned six search results: three definitions of a function named “remove” (315, 330, and 335), and three usages of a function named “remove” (320, 325, and 340). The definitions and usages span two function signatures—“int remove(bool argument1)” and “void remove(string argument1)”—each with the function name “remove,” as shown by 305 and 310. The six search results are grouped according to the function signature with which each is associated. While actual code is not used in the example, it will be appreciated that the definitions and usages would appear between the “<” and “>” signs. Above each search result, the path to the file containing either the definition or the usage may be displayed, together with the line number(s) where it can be found in the file (as shown in FIG. 3). In addition to the grouping, the groups themselves are ranked—in this example, by the number of usages of each function signature—such that the group defined by the “int remove(bool argument1)” function signature is ranked before the other group, because the 310 group contains more function usages than the 305 group. Similarly, the function definitions and function usages also may be ranked within each group, according to any of the methods described herein.

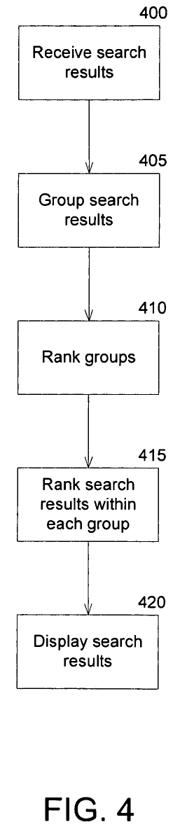

FIG. 4 is a flowchart that illustrates generally a process of grouping and ranking function search results. At block 400, the function search results are received in response to a function search query performed on a source code repository, which search results include both function definitions and function usages. At block 405, the search results are grouped according to, for example, function signature. The groups are then ranked according to, for example, the number of function definitions that belong to each group, as illustrated at block 410. At block 415, the search results within each group are ranked, according to any of various methods, as described herein. The grouped and ranked search results are then displayed to a user, as shown at block 420.

The sequence and numbering of blocks depicted in FIG. 4 is not intended to imply an order of operations to the exclusion of other possibilities. Those of skill in the art will appreciate that the foregoing systems and methods are susceptible of various modifications and alterations. For example, it may be the case that the search results are not ranked within their respective groups, in which case block 415 may not be a part of the process.

Those of skill in the art also will appreciate that the methods described herein may be performed on a computer which executes instructions stored on a computer-readable medium. The medium may comprise a variety of volatile and non-volatile storage devices, systems, or elements, including but not limited to solid-state memory, fixed media devices, and removable media which may be used in computers having removable media devices.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of sorting a plurality of search results associated with a function search performed on a source code repository, said method comprising using a processor to perform the steps of:
receiving the search results, wherein each search result comprises one of:
a function definition associated with the function search; and
a function usage associated with the function search;
grouping the search results into at least one of plurality of groups according to a grouping function;
ranking the groups according to a first ranking function; and
displaying the grouped and ranked search results.

2. The method of claim 1 wherein the grouping function defines the groups based on the function definitions, wherein:
each function usage is associated with a function definition; and
each function usage is grouped according to the function definition with which it is associated.

3. The method of claim 2 wherein the association between each function usage and a function definition is informed by at least a package to which the function usage and function definition belongs.

4. The method of claim 1 wherein the grouping function groups the search results according to function signature, wherein each function definition and function usage is associated with a function signature.

5. The method of claim 4 wherein the first ranking function is informed by at least one factor selected from the group consisting of:
the number of function definitions associated with each group;
the number of function usages associated with each group;
a measure of the diversity of the function definitions associated with each group; and
a measure of the diversity of the function usages associated with each group.

6. The method of claim 1 further comprising clustering, within each group, the search results that comprise function usages.

7. The method of claim 6 wherein said clustering comprises:
grouping each function usage into one of a plurality of clusters, wherein each cluster is associated with a pattern of code statements;

8. The method of claim 7 further comprising ranking the clusters according to a second ranking function.

9. The method of claim 8 wherein the second ranking function is informed by the number of function usages grouped into each cluster.

10. The method of claim 7 further comprising ranking the function usages within each cluster according to a third ranking function.

11. The method of claim 10 wherein the third ranking function is informed by how closely a function usage tracks the pattern of code statements associated with the cluster to which the function usage belongs.

12. The method of claim 10 wherein the third ranking function is informed by a number of lines comprising the pattern of code statements within the function usage.

13. The method of claim 10 wherein the third ranking function is informed by a readability metric.

14. The method of claim 13 wherein the readability metric is based on a volume of comments associated with the function usage.

15. The method of claim 13 wherein the readability metric is based on the lengths of a plurality of expressions that comprise the function usage.

16. A system, comprising:
a source code repository for storing source code files;
a grouping module for:
receiving the results of a search performed on the source code repository; and
grouping the search results according to a grouping function;
a first ranking module for:
receiving the groups of search results; and
ranking the groups according to a first ranking function,
wherein the search results comprise function usages and function definitions.

17. The system of claim 16 further comprising a second ranking module for:
receiving the groups, as ranked; and
within each group, ranking the search results.

18. The system of claim 16 further comprising a clustering module for:
receiving the groups, as ranked; and
within each group, grouping the search results comprising function usages into at least one of a plurality of clusters.

19. The system of claim 18 wherein the clustering module ranks the clusters within each group.

20. The system of claim 18 wherein the clustering module ranks the search results within each cluster.

21. A computer-readable medium encoded with a set of instructions which, when performed by a computer, perform a method of sorting a plurality of search results associated with a function search performed on a source code repository, said method comprising:
receiving the search results, wherein each search result comprises one of:
a function definition associated with the function search; and
a function usage associated with the function search;
grouping the search results into at least one of plurality of groups according to a grouping function;
ranking the groups according to a first ranking function; and
displaying the grouped and ranked search results.

22. The computer-readable medium of claim 21 wherein the grouping function defines the groups based on the function definitions, wherein:
each function usage is associated with a function definition; and
each function usage is grouped according to the function definition with which it is associated.

23. The computer-readable medium of claim 22 wherein the association between each function usage and a function definition is informed by at least a package to which the function usage and function definition belongs.

24. The computer-readable medium of claim 21 wherein the grouping function groups the search results according to function signature, wherein each function definition and function usage is associated with a function signature.

25. The computer-readable medium of claim 24 wherein the first ranking function is informed by at least one factor selected from the group consisting of:
the number of function definitions associated with each group;
the number of function usages associated with each group;
a measure of the diversity of the function definitions associated with each group; and
a measure of the diversity of the function usages associated with each group.

26. The computer-readable medium of claim 21 further comprising clustering, within each group, the search results that comprise function usages.

27. The computer-readable medium of claim 26 wherein said clustering comprises:
grouping each function usage into one of a plurality of clusters, wherein each cluster is associated with a pattern of code statements;

28. The computer-readable medium of claim 27 further comprising ranking the clusters according to a second ranking function.

29. The computer-readable medium of claim 28 wherein the second ranking function is informed by the number of function usages grouped into each cluster.

30. The computer-readable medium of claim 27 further comprising ranking the function usages within each cluster according to a third ranking function.

31. The computer-readable medium of claim 30 wherein the third ranking function is informed by how closely a function usage tracks the pattern of code statements associated with the cluster to which the function usage belongs.

32. The computer-readable medium of claim 30 wherein the third ranking function is informed by a number of lines comprising the pattern of code statements within the function usage.

33. The computer-readable medium of claim 30 wherein the third ranking function is informed by a readability metric.

34. The computer-readable medium of claim 33 wherein the readability metric is based on a volume of comments associated with the function usage.

35. The computer-readable medium of claim 33 wherein the readability metric is based on the lengths of a plurality of expressions that comprise the function usage.
